(19) United States
(12) Patent Application Publication
(10) Pub. No.: US 2007/0239691 A1
(43) Pub. Date: Oct. 11, 2007

(54) OPTIMIZATION TECHNIQUES FOR LINEAR RECURSIVE QUERIES IN SQL

(76) Inventors: Carlos Ordonez, Houston, TX (US); Michael Rote, San Diego, CA (US)

Correspondence Address: JAMES M. STOVER;NCR CORPORATION, 1700 SOUTH PATTERSON BLVD, WHQ3, DAYTON, OH, 45479, US

(21) Appl. No.: 11/696,859

(22) Filed: Apr. 5, 2007

Related U.S. Application Data
(60) Provisional application No. 60/789,952, filed on Apr. 6, 2006.

(51) Int. Cl. G06F 17/30

(52) U.S. Cl. 707/3

(57) ABSTRACT

A system and method of evaluating an SQL recursive query having one or more base select statements and one or more recursive select statements. In one technique the query relates to a base table and has a filter condition on one or more columns from a result table returned by the query. The technique includes the steps of receiving the query to be evaluated, evaluating a base step by evaluating one or more of the base select statements, evaluating one or more recursive steps by evaluating one or more of the recursive select statements, evaluating the filter condition prior to evaluating any of the recursive steps, and returning the result of the query.

### BACKGROUND

Computer systems generally include one or more processors interfaced to a temporary data storage device such as a memory device and one or more persistent data storage devices such as disk drives. Data is usually transferred between the memory device and the disk drives over a communications bus or similar. Once data has been transferred from a disk drive to a memory device accessible by a processor, database software is then able to examine the data to determine if it satisfies the conditions of a query.

A database is a collection of stored data on one or more of the above disk drives. The stored data is logically related and is accessible by one or more users. A popular type of database is the relational database management system (RDBMS) which includes relational tables made up of rows and columns (also referred to as tuples and attributes). Each row represents an occurrence of an entity defined by a table, with an entity being a person, place, thing, or other object about which the table contains information. To extract data from or to update a relational table in an RDBMS, queries according to a standard database-query language (e.g. structured query language or SQL) are used. Examples of SQL include INSERT, SELECT, UPDATE and DELETE. Recursion is available in SQL with syntactic constructs to define recursive views and recursive derived tables. SQL syntax for recursive queries is also available in relational database management systems (RDBMS).

Recursive queries have many applications in relational databases. The following are representative examples. Consider a table with employee/manager information with one column for the employee ID and another column for the employee ID of the manager/supervisor. Examples of recursive queries are “who are all the employees that are managed directly or indirectly by person X?” or “is person X under person Y in the organization?”.

There might be a table relating pairs of parts in a manufacturing environment where one column identifies one part and the second column corresponds to a subpart in a hierarchical fashion. Recursive query examples are “list all subparts of part X” and “how many subparts does part X have two levels below?”.

Assume there is a geographical table with locations where each row indicates there exists a road (with distance as an attribute) between two locations. Recursive queries are “how many different routes are there between two locations?”, “what locations cannot be reached from location X?”, “which locations can be reached in less than 500 km from X?” or “which is the shortest path between X and Y?”.

Recursive queries present many challenges for query optimization in a relational DBMS. For example the user cannot specify standard SQL clauses such as DISTINCT or GROUP-BY inside the query. Specifying filter conditions such as WHERE clauses can be error prone. Indexing is not as straightforward as the case of joining two tables. In a recursive case base table T is joined over and over to multiple result tables to produce the union of all partial result tables. In this case the index is critical.

### SUMMARY

Described below are methods of evaluating an SQL recursive query having one or more base select statements and one or more recursive select statements.

In one technique the query relates to a base table and has a filter condition on one or more columns from a result table returned by the query. The technique includes the steps of receiving the query to be evaluated, evaluating a base step by evaluating one or more of the base select statements, evaluating one or more recursive steps by evaluating one or more of the recursive select statements, evaluating the filter condition prior to evaluating any of the recursive steps, and returning the result of the query.

In a further technique the query simply relates to a base table. The technique includes the steps of receiving the query to be evaluated, evaluating a base step by evaluating one or more of the base select statements to create a result table, deleting duplicate rows from the result table, evaluating one or more recursive steps by evaluating one or more of the recursive select statements, and returning the result of the query.

In a further technique the query relates to a base table and has an aggregate function on one or more columns from a result table returned by the query. The technique includes the steps of receiving the query to be evaluated, evaluating a base step by evaluating one or more of the base select statements, evaluating one or more recursive steps by evaluating one or more of the recursive select statements, evaluating the aggregate function prior to evaluating any of the recursive steps, and returning the result of the query.

In a further technique the query relates to a base table and has a join operation between a result table returned by the query and a further table. The technique includes the steps of receiving the query to be evaluated, evaluating a base step by evaluating one or more of the base select statements, evaluating one or more recursive steps by evaluating one or more of the recursive select statements, evaluating the join operation, and returning the result of the query.

In a further technique the query relates to a base table and has a join operation. The technique includes the steps of receiving the query to be evaluated, defining at least one index for the base table, defining at least one index for a result table returned by the query, evaluating the join operation, and returning the result of the query.

Also described below are systems and computer programs that embody the above techniques.

### BRIEF DESCRIPTION OF THE DRAWINGS

FIG. 1 is a block diagram of an exemplary large computer system in which the techniques described below are implemented.

FIG. 2 is a block diagram of the parsing engine of the computer system of FIG. 1.

FIG. 3 is a flow chart of the parser of FIG. 2.

FIG. 4 is a graph showing how query evaluation time grows as number of vertices n increases.

FIG. 5 is a graph showing how query evaluation time grows as number of edges m increases.

FIG. 6 is a graph showing how query evaluation time grows as recursion depth k increases.

### DETAILED DESCRIPTION

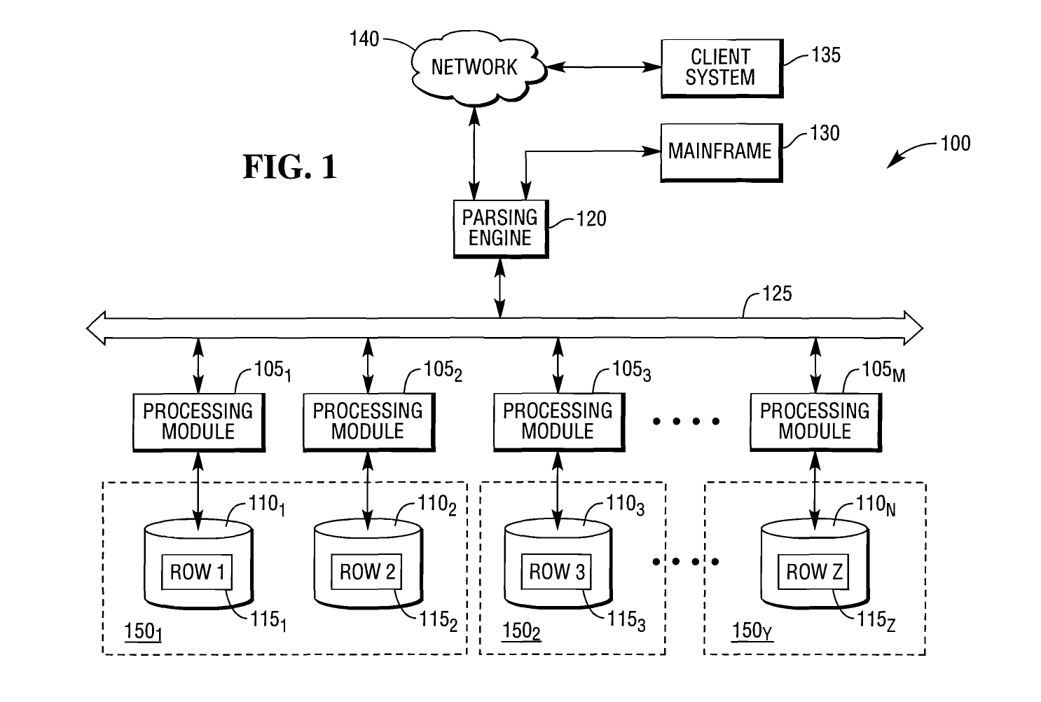

FIG. 1 shows an example of a database system 100, such as a Teradata Active Data Warehousing System available from NCR Corporation. Database system 100 is an example of one type of computer system in which the techniques of selective automatic refreshing of stored execution plans are implemented. In computer system 100, vast amounts of data are stored on many disk-storage facilities that are managed by many processing units. In this example the data warehouse 100 includes a Relational Database Management System (RDMS) built upon a Massively Parallel Processing (MPP) platform.

Other types of database systems, such as object-relational database management systems (ORDMS) or those built on symmetric multi-processing (SMP) platforms, are also suited for use here.

The database system 100 includes one or more processing modules 105_{1 . . . M} that manage the storage and retrieval of data in data storage facilities 110_{1 . . . N}. Each of the processing modules 105_{1 . . . M} manages a portion of a database that is stored in a corresponding one of the data storage facilities 110_{1 . . . N}. Each of the data storage facilities 110_{1 . . . N} includes one or more disk drives.

The system stores data in one or more tables in the data storage facilities 110_{1 . . . N}. The rows 115_{1 . . . Z} of the tables are stored across multiple data storage facilities 110_{1 . . . N} to ensure that the system workload is distributed evenly across the processing modules 105_{1 . . . M}. A parsing engine 120 organizes the storage of data and the distribution of table rows 115_{1 . . . Z} among the processing modules 105_{1 . . . M}. The parsing engine 120 also coordinates the retrieval of data from the data storage facilities 110_{1 . . . N} over network 125 in response to queries received from a user at a mainframe 130 or a client computer 135 connected to a network 140. The database system 100 usually receives queries and commands to build tables in a standard format, such as SQL.

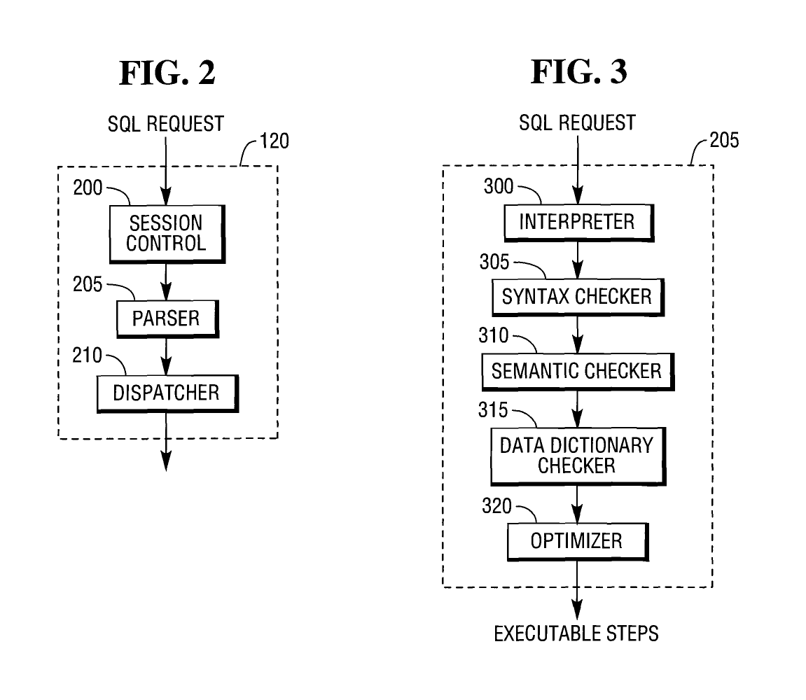

In one example system, the parsing engine 120 is made up of three components: a session control 200, a parser 205, and a dispatcher 210, as shown in FIG. 2. The session control 200 provides a log on and log off function. It accepts a request for authorization to access the database, verifies it, and then either allows or disallows the access.

Once the session control 200 allows a session to begin, a user may submit a SQL request, including a recursive query, which is routed to the parser 205. As illustrated in FIG. 3, the parser 205 interprets the SQL request (block 300), checks it for proper SQL syntax (block 305), evaluates it semantically (block 310), and consults a data dictionary to ensure that all of the objects specified in the SQL request actually exist and the user has the authority to perform the request (block 315). Finally, the parser 205 runs an optimizer (block 320) which develops the least expensive plan to perform the request.

The techniques described below optimize queries based on recursive views. Such queries can include any valid SQL clause treating the recursive view as a table. Five optimization techniques for recursive queries in SQL are described, namely (1) Early evaluation of row selection conditions, (2) deleting duplicate rows, (3) pushing aggregation, (4) early or late evaluation of non-recursive joins, (5) indexing base and result table for efficient join computation.

Some definitions are required before describing optimization.

A base table T is defined as T(i,j,v) with primary key (i,j) and v representing a numeric value. In practice T represents any table with relationships like employee information, distances between locations, parts and sub-parts, and so on. Table T is used as the input for recursive queries using columns i and j to join T with itself. R is the result table returned by a recursive query, with a similar structure to T. Table R is defined as R(d,i,j,v) with primary key (d,i,j), where d represents recursion depth, i and j identify result rows at one recursion depth and v represents some arithmetic expression (typically recursively computed). For practical reasons, it is assumed there is a recursion depth threshold k. A Cartesian product appearing in a recursive view can produce huge tables since R size will grow fast as recursion depth k grows. In general, this is caused by a user error because there is a missing join condition or the condition is not correctly written. This potential issue supports the idea of always setting a recursion depth threshold (k). R^{[k]} represents a partial result table obtained from k−1 self-joins having T as operand k times. The queries of interest are of the form: R^{[k]}=T join T join . . . join T.

An abstract framework for discussion uses graphs. G=(V,E) is a directed graph with n vertices and m edges. An edge in E links two vertices in V and has a direction. An edge can represent a parent/child relationship or a road between two locations. The above definition allows the existence of cycles in graphs. A tree is a particular case of a graph, where there is a hierarchical structure linking vertices and there are no cycles. There are two common representations for graphs; one is called the adjacency list and the other one is called the adjacency matrix. The adjacency list representation of a graph is a set L of edges joining vertices in V. If there is no edge between two vertices then there is no corresponding element in the list. Each edge has an associated weight (e.g. distance, capacity or cost). A path is defined as a subset of E linking two vertices in V. The adjacency matrix is an n×n binary matrix A, where entry Aᵢⱼ represents an edge from vertex i to vertex j. If G is an undirected graph then A is a symmetrical matrix. The value of Aᵢⱼ is 1/0 indicating presence/absence of an edge. Therefore, a row from table T represents a weighted edge between vertices i and j in list L, some value attribute of either i or j or an entry Aᵢⱼ of the adjacency matrix A. Table T has m rows (edges), iε{1, . . . , n} and, jε{1, . . . , n}.

The graphs on which optimizations are performed fall into three basic categories. The best type of graphs are binary trees, the worst type of graphs are complete graphs and sparse graphs lie somewhere between binary trees and complete graphs. Both sparse and complete graphs have cycles. Where the graph has n nodes, a binary tree typically has n−1 edges, Sparse graphs have 4n edges and complete graphs have n² edges.

What is computed is the transitive closure of G and the power matrix A^{k} in SQL. Both problems are similar, but their solution as queries is different. The transitive closure G* computes all vertices reachable from each vertex in G and is defined as: G*−(V,E′), where E′={(i, and j) s.t. exists a path between i and j}.

The power matrix A^{k} (A multiplied by itself k times) contains the number of paths of length k between each pair of vertices and is defined as: A^{k}=πᵢ₌₁^{k}A.

In the employee/manager example, V is the set of employees and E are the relationships between employees and their immediate managers. For the manufacturing example, V is the set of parts and E represents part/subpart relationships. For a geographical database, V are the locations and E represents the existence of a road or a distance between two locations.

One of the mechanisms to define recursive queries in the database 100 is a recursive view. Syntax for an equivalent SQL construct for derived tables (WITH RECURSIVE) is omitted. A recursive view has one or more base (also called seed) select statements without recursive references and one or more recursive select statements. Recursion appears in the join in a recursive select statement, where the declared view name appears again in the “FROM” clause. In general, a join condition can be any comparison expression, for example an equality (i.e. natural join). To avoid long runs with large tables, infinite recursion with graphs having cycles or infinite recursion with an incorrectly written query, it is advisable to add a “WHERE” clause to set a threshold on recursion depth, constant k.

The statement without the recursive join is called the base step and the statement with the recursive join is called the recursive step. Both steps can appear in any order, but for clarity purposes in the SQL examples below, the base step appears first.

Recursive views for computing the transitive closure and the power matrix are defined. The following view computes the transitive closure of a graph G stored as an adjacency list in T with a maximum recursion depth k=8. Columns i,j,v are qualified with the corresponding table/view name to avoid ambiguity. The view computes the length/cost v of each path, but it will be irrelevant for the transitive closure.

CREATE RECURSIVE VIEW
R(d,i,j,v) AS (

| SELECT 1,i,j,v FROM T /*base step */ | |
|---|---|
| UNION ALL | |
| SELECT d + 1,R.i,T.j,R.v + T.v | |
| FROM R JOIN T ON R.j = T.i | /*recursive step */ |
| WHERE d < 8); | |

CREATE VIEW TransitiveClosureG AS (

SELECT DISTINCT i,j FROM R);

The following code computes the power matrix A^{k} of the adjacency matrix A, stored in table T, up to k=4. The recursive view looks similar to the statement above, but the arithmetic operation is ‘*’ rather than ‘+’ and there is an extra statement needed to perform aggregation. This SQL code can be made more efficient when A has zeroes by deleting the corresponding rows from T where v=0.

CREATE RECURSIVE VIEW
R(d,i,j,v) AS (

| | |
|---|---|
| SELECT 1,i,j,v FROM T | /* base step */ |
| UNION ALL | |

| SELECT d + 1,R.i,T.j,R.v*T.v | |
|---|---|
| FROM R JOIN T ON R.j = T.i | /* recursive step*/ |
| WHERE d <4); | |

CREATE VIEW A^{K} AS (

SELECT d,i,j,sum(v) AS v FROM R
GROUP BY d,i,j);

In general, the user can write queries or define additional views on R treating it as any other table/view. Recursive views have several constraints. There must be no “group by”, “distinct”, “having”, “not in”, “outer join”, “order by” clauses inside the view definition. However, such syntactic constructs can appear outside in any query calling the view, leaving the optimization task open for the query optimizer. Recursion must be linear; non-linear recursion is not allowed (i.e. view name appearing twice or more times in the internal “from” clause). Recursive views cannot be nested to avoid indirect infinite recursion by mutual reference. The optimization of queries with the recursive views introduced above are described, which represent linear recursive queries.

The algorithm to evaluate a recursive query comes from deductive databases and is called semi-naïve. R^{[s]} is the result table after step s, where s=1 . . . k. The base step produces R^{[1]}=T. The recursive steps produce R^{[2]}=T join T=R^{[1]} join T. R^{[3]}=T join T join T=R^{[2}] join T, . . . , and so on. In general R^{[s]}=R^{[s-1]} join T. Finally, R=R^{[1]}∪R^{[2]}∪ . . . ∪R^{[k]}

Since step s depends on step s−1 the query evaluation algorithm is sequential and works in a bottom-up fashion. If R^{[s]} is empty, because no rows satisfy the join condition, then query evaluation stops sooner.

The query evaluation plan is a deep tree with k−1 levels that may be stopped early if some partial table becomes empty. The tree has k leaves with operand table T, k−1 join operator nodes with one operand being the partial result R^{[s]} and the other one being the input table T.

In practical terms the plan consists of a while loop of k−1 joins assuming bounded recursion, where each join is evaluated with an equivalent non-recursive “SELECT” statement joining the previous result table R^{[s-1]} and T to produce R^{[s]}.

The techniques described below optimize queries based on the recursive views described above. Such queries can include any valid SQL clause treating the recursive view as a table. Five optimization techniques for recursive queries in SQL are described, namely (1). Early evaluation of row selection conditions, (2) deleting duplicate rows, (3) pushing aggregation, (4) early or late evaluation of non-recursive joins, and (5) indexing base and result table for efficient join computation.

### Early Evaluation of Row Selection Conditions

Early evaluation of row selection conditions may be used when there is a “WHERE” clause specifying a filter condition on columns from R, where R is the result table returned by a recursive query. When directed graph G has cycles the recursion may become infinite; this becomes a practical problem for many applications. The use of a “WHERE” clause is the only way to guarantee a recursive query will stop in general. These queries are of the form

SELECT i,j,v FROM R WHERE <condition>;

The intention behind this technique is to evaluate selection (σ) of rows and projection (π) as early as possible. The rationale behind such optimization is that a join operation can operate on smaller tables reducing work. This optimization involves automatically transforming the given query into an equivalent query that is evaluated faster. Two cases arise in the application of this technique to recursive queries. The first case is given by a condition on the columns from the primary key of R other than d (ie i,j which are the result rows at one recursion depth). The second case is given by a condition on non-key columns arithmetic expression v or recursion depth d, that change at each recursive step.

In the first case, if there is a “WHERE” condition on a column belonging to the primary key (i or j), and the column does not participate in the join condition then the “WHERE” condition can be evaluated earlier. In this manner each intermediate table is smaller. The transitive closure view was described above. If the user is only interested in vertices reachable from vertex 1 the following query gives the answer.

SELECT i,j
FROM transitiveClosureG
WHERE i = 1;

The following equivalent query is evaluated from R:

SELECT DISTINCT i,j
FROM R WHERE i = 1;

The clause “WHERE” i=1” can be evaluated earlier during the recursion. It can be evaluated at the base step and at each recursive step, with caution, as explained below. Then the earliest it can be evaluated is at the base step to produce a subset of T, stored in R^{[1]}. This optimization propagates a reduction in the size of all intermediate tables R^{[s]}. Then the base step of the recursive view SQL code described above is rewritten as follows:

SELECT 1,i,j,v/* base step*/
FROM T WHERE i = 1
UNION ALL

Evaluating “WHERE” i=1” in the recursive step can cause difficulties. First of all, i must be qualified. Using “WHERE” T.i=1” would produce incorrect results because it would only include vertex 1. The recursive step uses T.i in the “WHERE” clause, but not on the projected columns. Conversely, it uses R.i in the projected columns and not on the “WHERE” clause. Evaluating “WHERE” R.i=1” produces correct results because R.i is not part of the join condition, but in this case it is redundant because the partial result table R^{[s-1]}, only contains rows satisfying R.i=1, propagated from the base step. Therefore, in this case it is sufficient to evaluate selection on key i on the base step. This optimization cannot be applied to the next query:

SELECT i,j,v
FROM A^{k} WHERE j = 1;

The reason that hinders pushing the WHERE clause is because R.j is part of the join condition R.j=T.i. Even further, “WHERE T.j=1” cannot be evaluated neither on the base step nor on the recursive step.

A similar reasoning applies to more complex WHERE expressions. For instance, selecting a row/column from the power matrix A^{k}, using a query such as:

SELECT i,j,v
FROM A^{k}
WHERE d = 10 and i = 1 and j = 1

This query can be evaluated more efficiently by filtering with ‘WHERE T.i=1” in the base step of R and “WHERE R.i=1” at each recursive step. However, “WHERE R.i=1” cannot be pushed into the base step because it uses T; “WHERE T.j=1” cannot be pushed either because all rows from T where j=1 are needed for the next recursive step.

In the second case, row selection with general “WHERE” conditions on v is hard to optimize whereas conditions on d are easier to optimize. The corresponding “WHERE” clause may be pushed into both the base and recursive step depending on how v is computed. One possibility is where v is recursively computed (with addition or product) and the second possibility is where v is not recursively computed when it is an attribute of vertex i or vertex j.

If the filter condition is of type “WHERE v≦v_{U}” and v is recursively incremented then the query can stop at some step. If all T rows satisfy v>0 and v is incremented at each step then the query will stop. But if there exist rows such that v=0 or v<0 then the query may not stop. Only in the case that v>0 for all rows and v increases monotonically can the expression “WHERE” v≦v_{U}” be evaluated at each recursive step. By a similar reasoning, if the condition is v≧v_{L} and v>0 in every row then the query may continue indefinitely; then “WHERE v≧v_{L}” cannot be evaluated at each recursive step. For instance, the power matrix may produce an infinite recursion for cyclic graphs selecting rows with “WHERE” v>0” and d has no threshold. The transitive closure will eventually stop when the longest path between two vertices is found if there are no cycles, but it may produce an infinite recursion if there are cycles. If v is not recursively computed then v may increase or decrease after each recursive step; then it is not possible to push the “WHERE” clause because discarded rows may be needed to compute joins.

Recursion depth d is a particular case of v. Depth d monotonically increases at each recursive step since it is always incremented by 1. The filter expression “WHERE d≦k” sets a limit on recursion depth and then query evaluation constitutes an iteration of at most k steps. This case is used by default because recursion is guaranteed to stop. With an expression d≧k recursive steps may continue beyond k, perhaps indefinitely. It is assumed no recursive view is defined with such condition. Also, “WHERE” d≧k” cannot be evaluated earlier because it would discard rows needed for future steps.

### Deleting Duplicate Rows

In some cases it is desirable to compute the transitive closure of G, but not v, the weight/distance of each path. What is needed is all vertices that are reachable from each vertex. The recursive view described above is set out below:

SELECT DISTINCT i,j
FROM R;

Query evaluation is affected by how connected G is. If G is complete then there are O(n) paths for each pair of vertices. If G is dense then there are probably two or more paths between vertices. This will produce duplicate rows that in turn will increase the size of partial tables after each recursive step. On the other hand, if G is sparse then there are fewer paths with less impact on join performance. In particular, if G is a tree there is only one path between pairs of vertices resulting in good join performance without using this optimization.

Recursive queries are optimized in this technique by deleting duplicate rows at each step. If there are duplicate rows in T for any reason deleting them reduces the size of the temporary table from the base step. If there are no duplicate rows this optimization has no effect on table sizes. Applying this optimization the equivalent query used to evaluate the base step is:

SELECT DISTINCT 1,i,j
FROM T /*base step */

The following equivalent query eliminates duplicates within one recursive step:

SELECT DISTINCT d + 1,R.i.T.j
FROM R JOIN T ON R.j=T.i /* recursive step */
WHERE d < k

Assuming G is a complete graph, if no optimization is done each recursive step s produces n^{s+1} rows. Similarly, time complexity is O(n^{k+1}) without optimization and O(kn³) with optimization at maximum depth k. This produces a significant speedup. A last “SELECT” with DISTINCT on R statement is required at the end to get all distinct rows regardless of depth. This optimization is not applicable to the power matrix A^{k}.

### Pushing Aggregation

Pushing aggregation is applicable to queries doing aggregations on the recursive view R. This technique evaluates the “group by” clause and the aggregate function at every step instead of doing it at the end of the recursion. This optimization is applicable when the desired “group by” clause includes columns i, j, that are part of the primary key of R or R^{[s]}. The power matrix A^{k} is computed from the matrix power view as:

SELECT d,i,j, sum(v)
FROM R
GROUP BY d,i,j
WHERE d = k;

In a programming language like C++ or Java, a square matrix A multiplication by itself requires n³ operations because each product matrix entry is multiplied n times. That is, matrix multiplication is O(n³). Such time complexity changes with recursive views as recursion goes deeper depending on evaluation. Evaluating the aggregation/“group by” at the end produces n^{s+1} rows after step s because number is successively multiplied n times and no aggregation is done. Therefore, R^{[k]} has n^{k+1} rows. Then time complexity is O(n^{k+1}). Clearly, time will grow rapidly.

The optimization proposed in this technique evaluates the “group by” clause at each step (base and recursive). That is, the aggregation is evaluated as early as possible. The equivalence between both queries results from the distributive laws of arithmetic operations + and *. The equivalent query for the base step is:

SELECT 1 AS d,i,j, sum(v)
FROM T/* base step */
GROUP BY d,i,j

In general this query produces no performance improvement if there are no duplicate keys (i,j) in T, which is our assumption. The equivalent query evaluated at each recursive step, which for dense graphs is significantly faster, is:

SELECT d + 1,R.i,T.j,sum(R.v * T.v)
FROM R JOIN T ON R.j = T.i /* recursive step */
WHERE d < k
GROUP BY d,i,j

Evaluating the sum ( )/“group by” at each step produces a table R^{[s]} with n² rows resulting in a significant performance improvement. Then each recursive step will perform n³ multiplications. Time complexity is O(kn³), that grows much more slowly than O(n^{K+1}).

Going back to the transitive closure, this optimization is applicable for the following query since it involves the primary key of R. For instance, the next query computes the path with the longest distance between two locations at each depth. This is useful when there are two or more paths between locations.

SELECT d,i,j, max(v)
FROM R GROUP BY d,i,j;

This optimization can also be applied if the grouping is done on i,j but not d. In practical terms, this is the same case as having “group by” on all the primary key columns of R. Each step use the primary key of the partial aggregation table required, but a final “group by” is required anyway. Also, each recursive step must still store partial results at depth s=1. . . k. In the following query the v maximum can be computed for every pair of vertices at each depth pushing “group by i,j”. The final aggregation gets the maximum across all depths.

SELECT i,j,max(v)
FROM R GROUP BY i,j;

This optimization is not directly applicable when the grouping columns do not include all columns of the primary key of R or the primary key of R^{[s]}, but it can be partially applied using all grouping columns eliminating redundant rows (if any).

This means partially grouping either on i or j. Examples are computing the total sum of salaries of all employees under each manager or computing the most expensive/cheapest subpart of each part. Such computations require “carrying” the aggregated salary of each sub-employee or the aggregated subpart cost at each step for the future aggregation. Consider the query based on the modified transitive closure view R, where v−T.v instead of v=R.v+T.v:

SELECT i, max(v)
FROM R GROUP BY i

Performing an early “GROUP BY i” would incorrectly eliminate rows with different paths from i to j. This would in turn hinder recursive joins on the condition R,j=T.i and would return several different terms from those in the view. Early aggregation with “GROUP BY i” is not possible because intermediate vertices at each recursion depth are needed to perform the next recursive step. Therefore, this optimization is not directly applicable. However, “GROUP BY i,j” can be evaluated at each step saving work by eliminating redundant rows; that is the case if there are two or more paths between i and j. Therefore, if the grouping expression is “GROUP BY i” or GROUP BY j” then “GROUP BY i, j” is pushed. This optimization is applicable to distribute aggregate functions, that include count( ), sum( ), min( ) and max( ).

This optimization has an important common property with respect to deleting duplicates. The basic similarity is that intermediate result tables become smaller. Assume many entries of A are equal. If “SELECT DISTINCT” is pushed and “GROUP BY” is not pushed then the optimization would eliminate duplicate rows after each recursive step; that would produce incorrect results since duplicate rows are needed for sums. On the other hand, if aggregations are pushed then deleting duplicate rows at each step is redundant. Therefore, pushing aggregations and deleting duplicate rows are independent optimizations.

### Early or Late Evaluation of Non-Recursive Joins

The optimization technique is applicable when a query has a non-recursive join between the recursive view and another table or when there are non-recursive joins inside the view definition. For graphs such queries are useful to get vertex properties. One application involves a join of R with another table N (different from T) to get vertex names. Assume vertex names and other vertex properties are stored in table N, which is defined as N(i,name) with primary key i.

There exist three equivalent strategies to get vertex names: (1) performing two joins between the final result table R and N to get names for i and j, without changing the recursive view definition; (2) changing the recursive view definition performing joins to get names at each step; (3) creating a denormalized table T_{N} joining T with N and substituting T for T_{N} inside the recursive view definition. The three strategies go from the latest join evaluation (as given the user) to the earliest possible (rewritten by the optimizer). Therefore, strategy (1) is called late non-recursive join, strategy (2) is termed continuous non-recursive join and strategy (3) is early non-recursive join.

The following query compute the transitive closure for strategy 1:

SELECT DISTINCT d,i,Nⱼ.name
FROM R JOIN N AS Nᵢ ON R.i − Nᵢ.i
JOIN N AS Nⱼ ON R.j = Nⱼ.i

In the query above after the transitive closure has been stored in R, two joins are performed to get each vertex name; N must be aliased to avoid ambiguity. The I/O cost for this query mainly depends on the size of R because N is comparatively smaller. N can be optimally indexed on i, but there are several indexing choices for R based on combinations of d,i,j. This is discussed further under index optimization.

Strategy 2 which requires computing a join at each step. The definition for R is changed introducing joins with N at each step (base and recursive). Non-recursive joins are computed at each recursive step yielding a total of 2k joins. The query for strategy (1) is equivalent to the union of partial result tables, where each non-recursive join is computed in an incremental fashion.

CREATE RECURSIVE VIEW
R(d,i,j,iname,jname,v) AS (

SELECT 1,i,j,Nᵢ.name,Nⱼ.name,v /* base step */
FROM T JOIN N AS Nᵢ ON R.i = Nᵢ.i

JOIN N AS Nj ON R.j = Nⱼ.i

UNION ALL
SELECT d + 1,R.i,T.j,Nᵢ.name, Nⱼ.name R.v + T.v
FROM R

JOIN T ON R.j = T.i /* recursive step */
JOIN N AS Nᵢ ON R.i = Nᵢ.i
JOIN N AS Nⱼ ON T.j = nⱼ.i

WHERE d < k);
SELECT DISTINCT i,j,iname,jname
FROM R;

Similarly to strategy (1), since there are two vertices per edge it is needed to alias N twice to avoid ambiguity. In this view definition the names computed in the previous step are not reused, which is inefficient. The view above is rewritten as the following view that reduces the number of joins by one half by retrieving the vertex name for i from R^{[s-1]}.

CREATE RECURSIVE VIEW
R(d,i,j,iname,jname,v) AS (

SELECT 1,i,j,Nⱼ.name,Nᵢ.name, v /* base step */
FROM T JOIN N AS Nⱼ ON R.i = Nⱼ.i

JOIN N AS Nⱼ ON R.j = Nⱼ.i

UNION ALL
SELECT d + 1,R.i,T.j,R.iname,Nⱼ.name,R.v + T.v
FROM R JOIN T ON R.j = T.i /* recursive step */

JOIN N AS Nⱼ ON T.j = Nⱼ.i

WHERE d < k);
SELECT DISTINCT i,j,iname,jname
FROM R;

The non-recursive join is evaluated both in the base step and in the recursive step. This leads to k+1 non-recursive joins with table N (two in the base step and k−1 on recursion). The base step requires two non-recursive joins to get vertex names, but the recursive step only requires one because R^{[s-1]} has the vertex names for R.i in column R.iname at step s. Nevertheless R^{[s-1]} cannot be reused to get the vertex name for T.j because, in general, it cannot be guaranteed that vertices reachable from T.i are available in R^{[s-1]}. This latter optimized sub-strategy is strategy (2).

Strategies (1) and (2) are equivalent. Strategy (1) gets names in a lazy manner, after the recursive view has been computed. Strategy (2) gets names in a more dynamic manner every time a recursive step is computed. This motivates another optimization. Based on the fact that the vertices names remain static, the query can be optimized by performing an early non-recursive join before the base step to create a denormalized table T_{N}. This third strategy is called early non-recursive join.

CREATE TABLE T_{N} AS (

SELECT

i,j,Nᵢ.name AS iname,Nⱼ.name AS jname,v

FROM T JOIN N AS Nᵢ ON T.i = Nᵢ.i

JOIN N AS Nj ON T.j = Nⱼ.i

) WITH DATA PRIMARY KEY (i,j);

The recursive view definition can be rewritten as follows using the denormalized table T_{N} instead of T, avoiding non-recursive joins inside the view altogether.

CREATE RECURSIVE VIEW
R(d,i,j,iname,jname,v) AS (

SELECT 1, i,j,iname,jname,v

| | |
|---|---|
| FROM T_{N} | /* base step */ |

UNION ALL
SELECT d + 1, R.i,T_{N}.j, R.iname, T_{N}.jname, R.v + T_{N}.v
FROM R JOIN T_{N} ON R.j = T_{N}.i /* recursive step */
WHERE d < k);

Strategy (3) may be more efficient than strategy (2) for two reasons: (1) the I/O cost per step is the same because each step produces the same columns. That is, each intermediate table has the same size. (2) k−1 joins are avoided. Therefore, k non-recursive joins are reduced to only two non-recursive joins. However, strategy (3) may not always be more efficient than performing a late non-recursive join because T_{N} has bigger rows than T. For instance, assume a denormalized table T_{N} is built with many property columns for i and j; this will impact I/O. Vertex names could be potentially retrieved from R^{[1]} since they are available for every edge after the base step, but that would require joining T with R twice producing a nonlinear (quadratic) recursion. That is not feasible in systems that are restricted to linear recursion.

It is also possible to define a reverse optimization when a recursive view has been defined as in strategy (2). Assume R was defined with non-recursive joins at each step to get names, but a query on R does not require such names. A simple optimization is introduced that avoids joins if selected columns do not include vertex names. This optimization has been called join elimination. Eliminating joins is particular useful to optimize queries generated by OLAP tools. Consider the standard query “SELECT DISTINCT i, j FROM R”. In this case it would be unnecessary to compute joins in each step to get vertex names. In general, join elimination is applicable when R was defined with non-recursive joins and the projected columns only come from R or T and not from any other table/view.

### Indexing Base and Result Table for Efficient Join

Let k be the recursion depth threshold. If the partial result table R^{[s]} becomes empty then recursion stops sooner at step s<k. The indexing schemes explained below are defined based on two facts. (1) Table T is used as a join operand k−1 times. (2) Table R is used as join operand k−1 times selecting rows from R^{[s-1]}. The final table R is computed as R=UₛR^{[s]}.

Three schemes are proposed to index the base table T and the result table R computed from the recursive view. Scheme 1 involves defining one index for T and one index for R based on the recursive join condition. The join expression is R.j−T.i. Therefore, T has an index on (i) and R has an index on (j) allowing non-unique keys in both cases. Scheme 2 defines one index for T and one index for R based on their respective primary keys. That is, T is indexed on (i,j) and R is indexed on (d,i,j). Scheme 3 combines scheme 1 and scheme 2 by defining two indices on each table, T and R. The explanation behind scheme 1 is that T and R are optimally indexed to perform a hash join based on R.j.=T.i. But having many rows satisfying the condition for each value of i may affect join performance because of hashing collisions. On the other hand, having a few rows (in particular one or zero) satisfying the join condition can improve hash join performance. In scheme 2 each recursive join cannot take advantage of the index because the join condition differs from the indexed columns, but each row can be uniquely identified efficiently. The optimizer uses a merge join making a full scan on both table R and table T at each step. However, only rows from R^{[s]} are selected before the join. In scheme 3 the optimizer can choose either index from schemes 1 and 2 to perform joins, depending on the characteristics of T and R, but scheme 3 incurs on higher overhead during insertion to maintain two indices per table. The three schemes are compared below.

### Experimental Evaluation

The techniques described above have been implemented and tested under a variety of conditions. Experiments have been performed on an NCR computer running the Teradata DBMS software V2R6. The system had four nodes with one CPU each running at 800 MHz, 40 AMPs (parallel virtual processors), 256 MB of main memory and 10 TB on disk. Each experiment was repeated five times and the average time measurement is reported.

TABLE 1
Characteristics for each type of graph G

| G type | m edges | cycles | complexity case |
|---|---|---|---|
| binary tree | n − 1 | N | best |
| sparse | 4n | Y | average |
| complete | n² | Y | worst |

TABLE 2
Number of rows in T varying n for binary
trees, sparse graphs and complete graphs.

| | number of rows in T (m) | | |
|---|---|---|---|
| n | G: binary tree | G: sparse | G: complete |
| 4 | 3 | 16 | 16 |
| 8 | 7 | 32 | 64 |
| 16 | 15 | 64 | 256 |
| 32 | 31 | 128 | 1024 |
| 64 | 63 | 256 | 4096 |
| 128 | 127 | 512 | 16384 |
| 256 | 255 | 1024 | 65536 |
| 512 | 511 | 2048 | 262144 |
| 1024 | 1023 | 4096 | 1048576 |
| 65536 | 65535 | * | * |
| 262144 | 262143 | * | * |

Two broad query optimization aspects are studied with three types of graphs: binary trees, sparse graphs and complete graphs. The first set of experiments evaluates the impact of each optimization leaving the other optimizations fixed. The second set of experiments shows scalability varying the two most important parameters: n, the number of vertices in G and k, the maximum recursion depth. Due to the intensive nature of recursive queries all optimizations are turned on by default. Otherwise, several recursive queries, even on small data sets, cannot be completed in reasonable time.

Optimization strategies for recursive queries with synthetic data sets are studied graphs. G were generated of varying number of vertices (n) and varying number of edges (m) to get different types of graphs. Each edge becomes a row in table T. Therefore, m−|T|. Three types of graphs were used. To evaluate the best case balanced binary trees were used, where G has n−1 edges (i,j) (j=1 . . . n,i=j/2) and no cycles; the number of rows grows linearly as n increases, m=n−1=O(n). To evaluate an average case sparse graphs were used with 4 random edges per vertex; the number of rows grows linearly as n increases, m=4n=O(n). To evaluate the worst case complete graphs were used having two directed edges for every pair of vertices (one from i to j and another from j to i) or equivalently two adjacency matrix entries (Aᵢⱼ and Aⱼᵢ₎). In complete graphs the number of rows grows quadratically as n increases, m=n²=O(n²). From a complexity point of view having only one, instead of two, edge(s) between vertices would yield m=n(n−1)=O(n²) anyway. Data sets characteristics are summarized in Table 1 and their number of rows are shown in Table 2. Entries marked “*” mean that the data set was not used in experiments because it represented a massive data set whose queries could not be completed in reasonable time. Only binary trees could be used with very large n.

For binary trees and sparse graphs Aᵢⱼ entries equal to zero are not included in T producing an automatic performance improvement to compute the power matrix Aₖ. This is based on the fact that aggregations on the full matrix A with zero entries are equivalent to aggregations on a “lean” matrix version excluding zeroes. The absence of row [i,j,v] from A means Aᵢⱼ=0. Otherwise, all computations for A^{k} on trees and sparse graphs would require the same time as complete graphs. Likewise, for the transitive closure an absence of a row from T means the corresponding edge is not present, as explained above.

### Early Evaluation of Row Selection

The performance gained by selecting rows as early as possible is studied. The queries are based on the transitive closure view with a clause “WHERE i=1” and kε{2,4,8,16}. For this particular query row selection can be evaluated in the base step, as explained above.

TABLE 3
Impact of early row selection for transitive
closure. Times in seconds.

| | | G: binary tree | | G: sparse | | G: complete | |
|---|---|---|---|---|---|---|---|
| n | k | opt = N | opt = Y | opt = N | opt = Y | opt = N | opt = Y |
| 32 | 2 | 2 | 2 | 3 | 2 | 2 | 2 |
| 32 | 4 | 3 | 3 | 4 | 2 | 3 | 2 |
| 32 | 8 | 4 | 3 | 5 | 3 | 4 | 3 |
| 32 | 16 | 5 | 5 | 8 | 5 | 7 | 5 |
| 64 | 2 | 2 | 2 | 2 | 2 | 2 | 2 |
| 64 | 4 | 3 | 2 | 4 | 2 | 5 | 2 |
| 64 | 8 | 4 | 3 | 6 | 3 | 9 | 4 |
| 64 | 16 | 5 | 5 | 8 | 5 | 17 | 5 |
| 128 | 2 | 3 | 2 | 2 | 2 | 7 | 2 |
| 128 | 4 | 3 | 2 | 4 | 2 | 18 | 3 |
| 128 | 8 | 5 | 3 | 6 | 4 | 39 | 3 |
| 128 | 16 | 6 | 5 | 8 | 5 | 84 | 6 |

Table 3 shows the effect of early row selection turning the early row selection optimization on (Y) and off (N). In general the gain in performance for small recursion depths (2 or 4) is marginal or zero. Differences come up with deeper recursion levels. For binary trees the gain in performance is small; there is an average difference for one second; times scale linearly in both cases. For the largest tree the difference in times becomes smaller. For sparse graphs the gain in performance is higher; time differences are around 2 seconds. Nevertheless, times scale linearly with and without this optimization. For larger sparse graphs queries run in half the time when the optimization is applied. For complete graphs differences in time are significant for large n. For the largest graph there is an order of magnitude change when this optimization is used at deep recursion levels (8 and 16). This optimization is valuable in all cases, but becomes more important for highly connected graphs when recursion depth is high.

The impact of this optimization will depend on the selectivity of the condition being pushed, like in non-recursive queries, but combined with recursion depth. A highly selective filter condition that can be pushed into the base step will significantly improve evaluation time. Selecting rows in a binary tree that correspond to leaves will evidently produce a great evaluation time decrease since recursion will stop immediately, but selecting rows corresponding to upper nodes with many children will produce smaller tables, but recursion will go deep anyway. On the other hand, if G is highly connected then cycles will force the query to be evaluated at many recursion depth levels, but the sizes of intermediate results will decrease, producing again an important improvement.

TABLE 4
Impact of deleting duplicates. Times in seconds.

| | | G: binary tree | | G: sparse | | G: complete | |
|---|---|---|---|---|---|---|---|
| n | k | opt = N | opt = Y | opt = N | opt = Y | opt = N | opt = Y |
| 4 | 2 | 2 | 2 | 5 | 4 | 5 | 5 |
| 4 | 4 | 3 | 3 | 6 | 6 | 5 | 6 |
| 4 | 8 | 3 | 3 | 9 | 7 | 15 | 7 |
| 4 | 16 | 3 | 3 | 1951 | 10 | 2430 | 13 |
| 8 | 2 | 2 | 2 | 5 | 5 | 5 | 6 |
| 8 | 4 | 3 | 3 | 7 | 7 | 8 | 7 |
| 8 | 8 | 3 | 3 | 12 | 10 | 1397 | 11 |
| 8 | 16 | 3 | 3 | * | 11 | * | 14 |
| 16 | 2 | 2 | 2 | 5 | 5 | 7 | 5 |
| 16 | 4 | 3 | 2 | 6 | 6 | 21 | 6 |
| 16 | 8 | 3 | 4 | 15 | 7 | * | 8 |
| 16 | 16 | 3 | 4 | * | 10 | * | 11 |

### Deleting Duplicates

The next set of experiments studies the impacts of deleting duplicate rows after each step for the transitive closure. The queries use the transitive closure view described above. The graphs used in these experiments are small, but queries become demanding as recursion depth grows. The optimizer performs a sort to eliminate duplicates every time the “DISTINCT” keyword appears. Binary trees are shown just for completeness since this optimization has no impact on them.

Table 4 summarizes results. The “opt” header indicates if the optimization is turned on (Y) or off (N). The entries marked with * mean the query could not be completed within one hour and then it had to be interrupted. The first general observation is that the transitive closure problem becomes intractable at modest recursion levels even with the small graphs studied. Binary trees times are similar with and without this optimization; there was only a single case where this optimization produced better times for binary trees. This is explained by the fact that there is at most one path between vertices and the overhead from the sorting process. In general, for sparse graphs n≧8 times is better. For complete graphs with large n and queries at recursion depth k=16 this optimization becomes essential: Queries could not end within one hour when this optimization was not used for n=16 and k=8. Time growth is minimal for binary trees when k or n grow. Time measurements grow fast when this optimization is not used for sparse and complete graphs. On the other hand, when duplicates are deleted times grow slowly as recursion goes deeper or data set size increases for sparse and complete graphs. Based on these experimental results it is concluded that duplicate rows should be deleted from intermediate tables whenever that does not affect the correctness of results or the semantics of the query.

### Pushing Aggregations

The following experiments show the performance gain obtained by pushing aggregations. These experiments are based on computing the power matrix A^{k} with the recursive view described above. As noted above, the graphs used are small, but query evaluation time grows fast as recursion depth grows. Binary trees are shown just for completeness since this optimization has marginal impact on them and introduces low overhead.

Table 5 compares the impact of this optimization in each type of graph. The “opt” header indicates if the optimization is used (Y) or not (N). The table entries marked with * mean the query could not be completed within one hour; such queries had to be stopped.

TABLE 5
Impact of Pushing Aggregation. Times in seconds.

| | | G: binary tree | | G: sparse | | G: complete | |
|---|---|---|---|---|---|---|---|
| n | k | opt = N | opt = Y | opt = N | opt = Y | opt = N | opt = Y |
| 4 | 2 | 2 | 2 | 5 | 4 | 5 | 4 |
| 4 | 4 | 3 | 3 | 5 | 4 | 5 | 4 |
| 4 | 8 | 3 | 3 | 12 | 4 | 6 | 5 |
| 4 | 16 | 3 | 3 | 21 | 7 | 1216 | 7 |
| 8 | 2 | 2 | 2 | 4 | 3 | 4 | 3 |
| 8 | 4 | 4 | 3 | 5 | 3 | 5 | 3 |
| 8 | 8 | 4 | 4 | 14 | 5 | 480 | 4 |
| 8 | 16 | 4 | 5 | * | 7 | * | 10 |
| 16 | 2 | 3 | 2 | 8 | 7 | 7 | 4 |
| 16 | 4 | 4 | 3 | 8 | 6 | 21 | 5 |
| 16 | 8 | 5 | 4 | 34 | 9 | * | 8 |
| 16 | 16 | 5 | 4 | * | 14 | * | 15 |

For binary trees the gain in performance, for bigger trees, is marginal; for small trees in some cases the evaluation time is slightly higher. Overall, for binary trees times are similar with and without pushing aggregation. Therefore, for binary trees this optimization introduces a small performance improvement and little overhead. For sparse graphs times are always better using this optimization; when recursion depth goes up to 16 and n=8 query evaluation cannot end in reasonable time. For complete graphs the gain performance becomes even more significant compared to sparse graphs. In fact, even for small graphs with 4 and 8 vertices the query cannot end in a few minutes and for graphs with 8 or 16 vertices the query cannot end at a recursion depth of k=16 within one hour. Time grows rapidly as recursion goes deeper when this optimization is not used for sparse and complete graphs. Times grow linearly and much slower as recursion goes deeper when this optimization is turned on. Based on these experimental results it is concluded that aggregations should be pushed whenever possible.

### Early or Late Evaluation of Non-Recursive Joins

The following experiments compare the strategies described above to evaluate non-recursive joins with the transitive closure recursive view. Strategy (2) (changing the recursive view definition performing joins to get names of each step) may be the most inefficient because it needs the evaluation of k+1 non-recursive joins, using the best scheme proposed (retrieving names from the previous step), whereas strategy (1) (performing two joins between the final result table R and N to get names for i and j) and strategy (3) (creating a denormalized table T_{N} joining T with N and substituting T for T_{N} inside the recursive view definition) only require two non-recursive joins each. Therefore, non-recursive join evaluation is compared with late (strategy (1)) and early (strategy (3)) evaluation. Table 6 compares efficiency on the three types of graphs varying n and k.

TABLE 6
Non-recursive join evaluation. Times in seconds.

| | | G: binary tree | | G: sparse | | G: complete | |
|---|---|---|---|---|---|---|---|
| n | k | Early | Late | Early | Late | Early | Late |
| 256 | 2 | 2 | 3 | 2 | 2 | 52 | 39 |
| 256 | 4 | 3 | 3 | 3 | 3 | 138 | 114 |
| 256 | 8 | 3 | 4 | 7 | 8 | 330 | 255 |
| 256 | 16 | 4 | 5 | 17 | 19 | 704 | 554 |
| 512 | 2 | 2 | 3 | 2 | 3 | 378 | 291 |
| 512 | 4 | 3 | 3 | 3 | 5 | 1044 | 785 |
| 512 | 8 | 3 | 4 | 16 | 19 | 2385 | 1804 |
| 512 | 16 | 4 | 5 | 49 | 56 | 5114 | 3897 |
| 1024 | 2 | 2 | 3 | 2 | 3 | 3117 | 2330 |
| 1024 | 4 | 2 | 3 | 3 | 6 | 8609 | 6285 |
| 1024 | 8 | 3 | 4 | 46 | 56 | 19667 | 14444 |
| 1024 | 16 | 4 | 5 | 166 | 194 | 42170 | 31203 |

For binary trees in every case early evaluation is slightly more efficient than late evaluation. Nevertheless, the difference in performance is marginal, which can be explained by the fact that there are no cycles and recursion stops around log₂(n). In sparse graphs early evaluation is clearly more efficient than late evaluation. The gap in performance is wider for large graphs with n=512 or n=1024, but relatively narrow for n=256. For complete graphs late evaluation is the best strategy. The difference in performance remains better for small and large graphs regardless of k. Given the existence of many paths between a pair of vertices the size of each row impacts I/O performance because each row from R and T have the two name columns. That is, recursive joins work with bigger rows. On the other hand, this I/O cost turns out to be less important for sparse graphs or trees: it is more expensive to join many small rows from R with N at the end of the recursion. In general k does not play a big row in changing the gap in performance or reversing the trend from a lower k to a higher k. Therefore, the type of graph is the most important factor for this optimization. For binary trees and sparse graphs it is better to transform the query to complete non-recursive joins as early as possible, but for complete graphs it is better to leave the query as it is. Time savings become important with large n and high k.

TABLE 7
Comparing indexing schemes. Times in seconds.

| | G | Indexing scheme | | |
|---|---|---|---|---|
| n | type | Indexing for Join | Index on PK | Both schemes |
| 32 | binary tree | 4 | 6 | 5 |
| 64 | binary tree | 4 | 6 | 4 |
| 128 | binary tree | 4 | 5 | 4 |
| 256 | binary tree | 4 | 5 | 4 |
| 512 | binary tree | 4 | 5 | 4 |
| 1024 | binary tree | 4 | 5 | 4 |
| 16 | sparse | 9 | 8 | 10 |
| 32 | sparse | 7 | 8 | 12 |
| 64 | sparse | 7 | 9 | 18 |
| 128 | sparse | 8 | 9 | 49 |
| 256 | sparse | 12 | 16 | 187 |
| 512 | sparse | 32 | 25 | 679 |
| 8 | complete | 8 | 10 | 9 |
| 16 | complete | 9 | 10 | 9 |
| 32 | complete | 9 | 10 | 13 |
| 64 | complete | 15 | 18 | 31 |
| 128 | complete | 72 | 65 | 128 |
| 256 | complete | 474 | 426 | 3826 |

### Indexing

The next set of experiments compares the three proposed indexing schemes. The transitive closure query is discussed. Default recursion depth is k=8. Table 7 summarizes results. Times for the power matrix are omitted, but they show a similar trend. In general, the index optimized for hash-joining T and R provides best performance when G is a tree or a sparse graph; this confirms recursion is efficient with sparse graphs. However, as G becomes more connected collisions affect hash join performance. For a sparse graph with n=512 or a complete graph with n≧128 indices on the table primary keys provide best performance. The trend indicates the difference in performance is not significant. Results indicate having two indices provides bad performance; the difference is marginal for binary trees, but it becomes significant for large sparse and complete graphs. The query optimizer can choose either index at run-time, but the maintenance overhead becomes significant. Based on these experiments it is concluded that optimal indexing for hash-joins provides best performance in most cases and little performance loss when G is highly connected.

### Scalability

The following experiments show scalability varying n, m and k with large data sets using all optimizations except early row selection and non-recursive join. The first goal is to understand how fast time grows as n, m or k increase. The second goal is to understand time growth for each type of graph. The number of vertices n was chosen based on m and how connected G was. Therefore, graphs for binary trees have higher n, graphs for complete graphs have a lower n and sparse graphs are in the middle.

### Graph Size

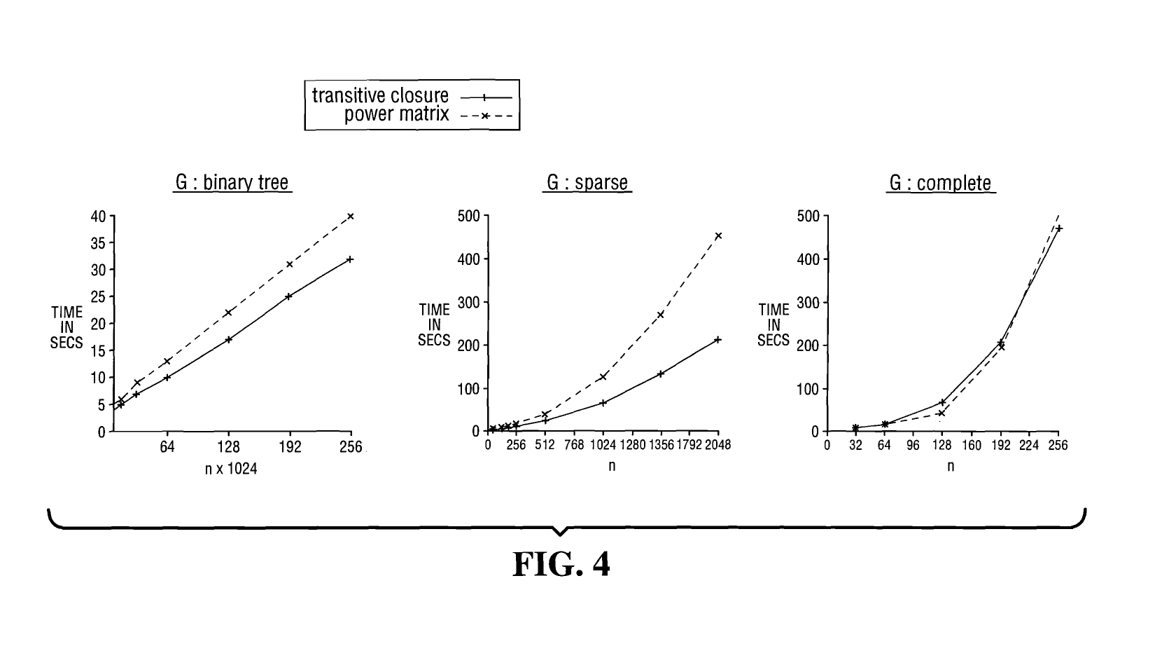

FIG. 4 shows how time grows as graph size n varies. Binary trees have a default recursion depth k=16, whereas sparse and complete graphs use k=8, for both the transitive closure and the power matrix. The value of n is much larger for binary trees; numbers shown must be multiplied by 1024 for correct interpretation. Refer to Table 2 to find m, the number of input rows. For binary trees time grows in a linear fashion. The trend is similar for the transitive closure and the power matrix. The small time difference can be explained by the aggregation needed to compute A^{k}. In sparse graphs time grows more rapidly in a super-linear fashion for both problems; the time difference becomes more significant as n grows. Queries on complete graphs show similar performance for both problems, but the trend indicates performance becomes worse for larger graphs for the power matrix. Times grow quadratically as expected. These experiments indicate that graph size can become a serious performance problem for highly connected graphs.

### Data Set Size

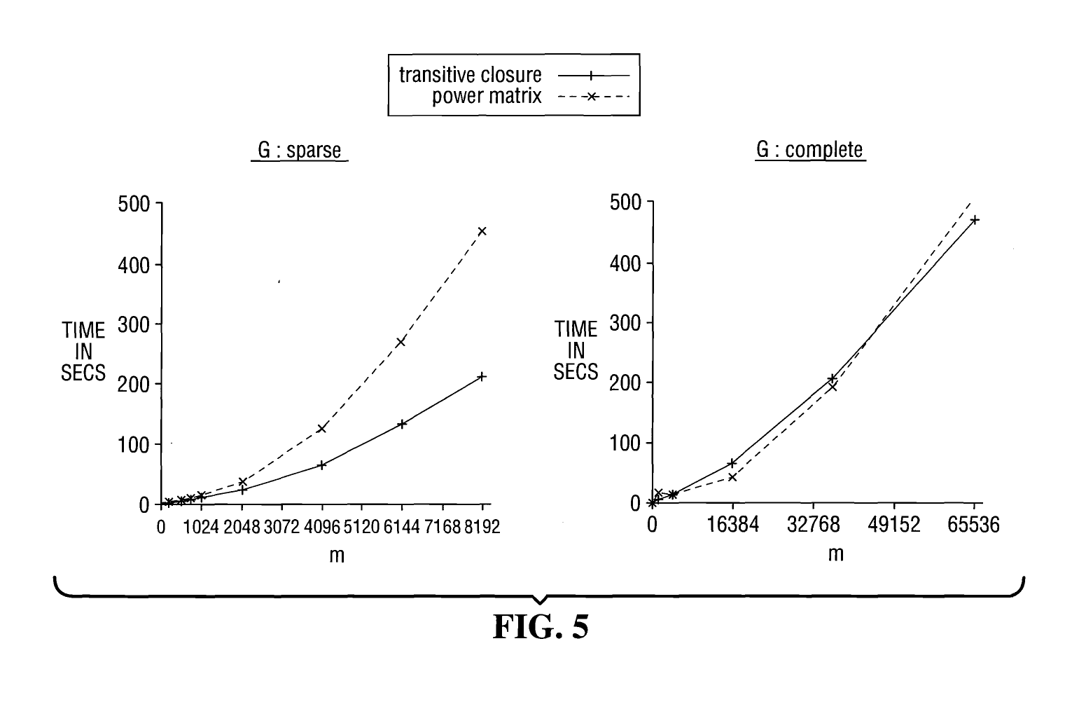

FIG. 5 shows how time grows as graph size m varies. The variable m is the number of edges and it is the same as data set size. Defaults are the same used for the previous experiments varying n. That is, the graphs varying n are now shown plotting m instead. The X axis scales change since the number of rows is plotted. The graph for the binary tree is omitted since it is practically the same. Results look similar to those varying n. Again, the trend is similar for the transitive closure and the power matrix showing a growing time difference. In sparse graphs time grows fast in a super-linear fashion for both problems; the time difference becomes more significant as n grows. Queries on complete graphs show very similar performance on both problems; time growth looks quadratric. These experiments indicate that highly connected graphs require a non-linear amount of work as m grows. In short, both n and m exhibit fast time growth as they increase for sparse and complete graphs and both exhibit linear behavior for binary trees.

### Recursion Depth

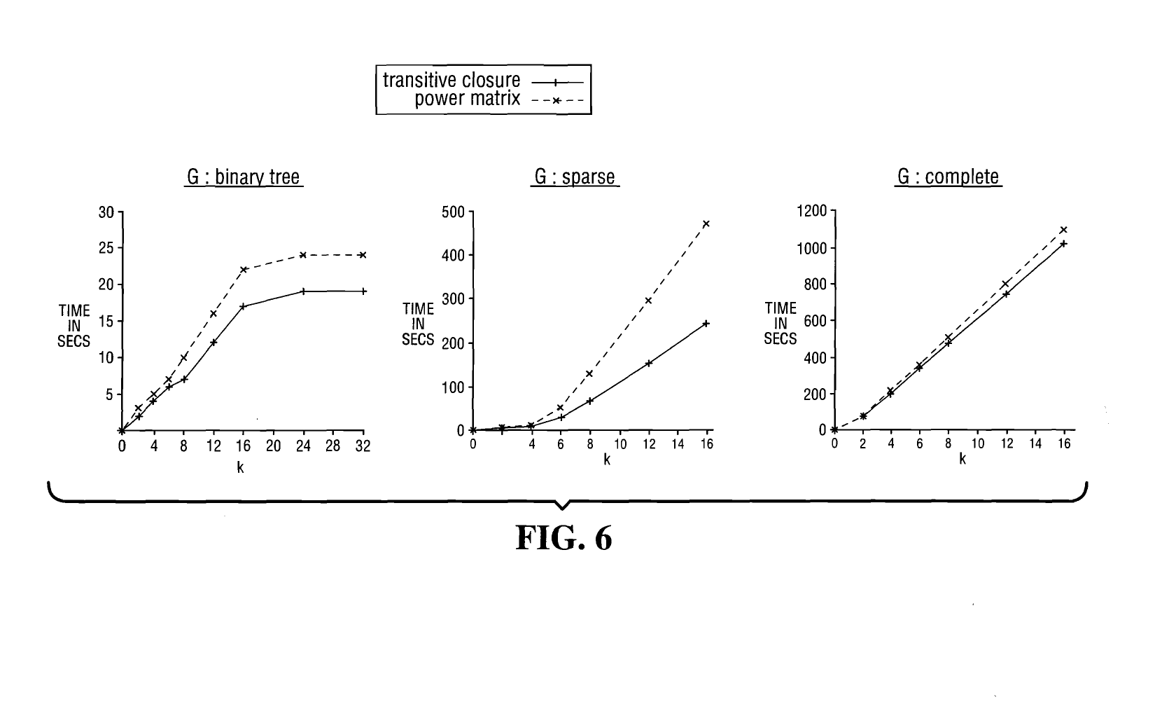

FIG. 6 shows time behavior as k varies with defaults n=131,072=128K for balanced binary trees, n=2,048 for sparse graphs, and n=256 for complete graphs. For binary trees time growth is linear and at the end time stops growing confirming G is a balanced binary tree because the partial result table becomes empty. For sparse graphs time grows rapidly on the lower end, but gradually becomes linear as recursion depth approaches k=8. This can be explained by the fact that each recursion level produces an increasingly more connected graph until it stabilizes. The time difference between the transitive closure and the power matrix becomes bigger as k grows, in a similar manner to the graphs showing n growth. In complete graphs time grows linearly as k grows. Results are consistent with n growth, showing there is a small difference between the two graph problems. These experiments show that recursion depth will produce a linear increase in time for sparse or complete graphs. Recursion depth in dense graphs may not be a significant performance problem provided it is bounded and all optimizations are turned on.

In summary, optimization of linear recursive queries in SQL have been described above. Two complementary and related problems were described above, namely computing the transitive closure of a graph and getting the power matrix of its adjacency matrix. Five query optimizations were studied, including early evaluation of row selection conditions, deleting duplicate rows, pushing aggregations, early or late evaluation of non-recursive joins and enhanced indexing for joining tables. Experiments studied the individual impact of each optimization and time scalability. Graph connectedness, recursion depth and data set size were the main performance factors analyzed by the experiments.

Three types of graphs were used to study query optimization: balanced binary trees, sparse graphs and complete graphs. Binary trees had no cycles and a linear number of edges; they correspond to hierarchically organized information. Sparse graphs had cycles and a still linear number of edges equal to a low multiple of the number of vertices; they correspond to geographical/location databases. Complete graphs had many cycles and a quadratic number of edges; they represent the worst case for recursive queries describing many complex relationships among objects.

Early evaluation of row selection had some impact on performance for binary trees and sparse graphs, but produced a significant speedup for complete graphs. A highly selective filter condition that can be pushed into the base step significantly improves evaluation time. Not every selection condition can be pushed into the base step.

Deleting duplicate rows and pushing aggregations turned out to be essential optimizations to get results in reasonable time for sparse and complete graphs due to cycles. Deleting duplicates produced comparatively a more significant impact than pushing aggregations for complete graphs. Recursion depth significantly impacted evaluation time of queries on sparse and complete graphs when aggregations were not pushed or when duplicates were not deleted. These two optimizations should be applied in general because their overhead is small for binary trees. Experiments indicate pushing aggregation can be an efficient alternative to delete duplicates instead of selecting distinct rows.

Early evaluation of non-recursive joins produced lower times than late evaluation for binary trees and sparse graphs, but increased time for complete graphs. Contrary to traditional SPJ query optimization knowledge, it may be better to perform joins first in some cases.

Having a non-unique index based on the recursive view join expression for each table was the best indexing scheme for binary trees and sparse graphs. Defining an index per table based on its primary key proved best for large (dense) complete graphs. Combining both indexing schemes provided the worst performance due to maintenance overhead even though the optimizer could choose either one during recursion.

Data set size and recursion depth had a strong impact on performance for sparse and complete graphs. Time scalability was evaluated using deletion of duplicate rows, pushing aggregation and choosing the best indexing scheme. In general, times for queries on binary trees scale linearly as the number of vertices or number of edges increase. Times on sparse and complete graphs increase quadratically as the number of vertices or number of edges increase. In general, times scale linearly as recursion depth grows on all types of graphs, but there is a stop point for binary trees given by the tree height.

The text above describes one or more specific embodiments of a broader invention. The invention also is carried out in a variety of alternative embodiments and thus is not limited to those described here. Those other embodiments are also within the scope of the following claims.

We claim:

1. A method of evaluating an SQL recursive query having one or more base select statements and one or more recursive select statements, the query relating to a base table and having a filter condition on one or more columns from a result table returned by the query, the method comprising:
receiving the query to be evaluated;
evaluating a base step by evaluating one or more of the base select statements;
evaluating one or more recursive steps by evaluating one or more of the recursive select statements;
evaluating the filter condition prior to evaluating any of the recursive steps; and
returning the result of the query.

2. The method of claim 1 wherein the result table(s) include(s) a primary key of one or more columns, and wherein the filter condition is on one or more of the primary key columns.

3. The method of claim 2 further comprising the step of evaluating the filter condition after evaluating one or more of the recursive steps.

4. The method of claim 2 wherein the filter condition includes a WHERE clause.

5. The method of claim 2 wherein result table(s) include(s) a recursive depth column, and wherein the filter condition is on the recursive depth column.

6. The method of claim 5 further comprising the step of evaluating the filter condition after evaluating one or more of the recursive steps.

7. The method of claim 6 wherein the filter condition sets a limit on recursion depth.

8. The method of claim 7 wherein the filter condition includes a WHERE clause.

9. The method of claim 2 wherein the result(s) table(s) include(s) non-key columns representing an arithmetic expression that is not a primary key, and wherein the filter condition is on one or more of the non-key columns.

10. The method of claim 9 wherein the filter condition sets an upper limit.

11. The method of claim 10 wherein the value of the arithmetic expression for all rows is greater than zero and increases monotonically, the method further comprising the step of evaluating the filter condition after evaluating one or more of the recursive steps.

12. A method of evaluating an SQL recursive query having one or more base select statements and one or more recursive select statements, the query relating to a base table, the method comprising:
receiving the query to be evaluated;
evaluating a base step by evaluating one or more of the base select statements to create a result table;
deleting duplicate rows from the result table;
evaluating one or more recursive steps by evaluating one or more of the recursive select statements; and
returning the result of the query.

13. The method of claim 12 further comprising the step of deleting duplicate rows from the result table after evaluating one or more of the recursive steps.

14. The method of claim 13 further comprising the step of deleting duplicate rows from the result table prior to returning the result of the query.

15. The method of claim 12 wherein the duplicate rows are deleted using a SELECT DISTINCT clause in the query.

16. The method of claim 13 wherein the duplicate rows are deleted after evaluating the one or more recursive steps using a SELECT DISTINCT clause in the query.

17. The method of claim 14 wherein the duplicate rows are deleted prior to returning the result of the query using a SELECT DISTINCT clause in the query.

18. A method of evaluating an SQL recursive query having one or more base select statements and one or more recursive select statements, the query relating to a base table and having an aggregate function on one or more columns from a result table returned by the query, the method comprising:
receiving the query to be evaluated;
evaluating a base step by evaluating one or more of the base select statements;
evaluating one or more recursive steps by evaluating one or more of the recursive select statements;
evaluating the aggregate function prior to evaluating any of the recursive steps; and
returning the result of the query.

19. The method of claim 18 wherein the result table(s) include(s) a primary key of one or more columns, and wherein the aggregate function is on the or each primary key column.

20. The method of claim 19 further comprising the step of evaluating the aggregate function after evaluating one or more of the recursive steps.

21. The method of claim 19 wherein the aggregate function includes a GROUP BY clause.

22. The method of claim 18 wherein the result table(s) include(s) a primary key of two or more columns, wherein the aggregate function is on not all of the primary key columns, and wherein the aggregate function is evaluated on all primary key columns.

23. The method of claim 22 further comprising evaluating the aggregate function on all primary key columns after evaluating one or more of the recursive steps.

24. The method of claim 22 wherein the aggregate function includes a GROUP BY clause.

25. A method of evaluating an SQL recursive query having one or more base select statements and one or more recursive select statements, the query relating to a base table and having a join operation between a result table returned by the query and a further table, the method comprising:
receiving the query to be evaluated;
evaluating a base step by evaluating one or more of the base select statements;
evaluating one or more recursive steps by evaluating one or more of the recursive select statements;
evaluating the join operation; and
returning the result of the query.

26. The method of claim 25 further comprising the steps of:
evaluating the join operation after evaluating one or more of the recursive steps; and
evaluating the join operation after evaluating the base step.

27. The method of claim 25 further comprising the step of evaluating the join operation prior to evaluating the base step.

28. The method of claim 25 wherein the join operation includes a JOIN clause.

29. A method of evaluating an SQL recursive query having one or more base select statements and one or more recursive select statements, the query relating to a base table, and having a join operation, the method comprising:
receiving the query to be evaluated;
defining at least one index for the base table, and defining at least one index for a result table returned by the query;
evaluating the join operation; and
returning the result of the query.

30. The method of claim 29 wherein one index for the base table and one index for the result table are both defined based on the join operation.

31. The method of claim 29 wherein the base table and the result table include respective primary keys, and wherein one index for the base table and one index for the result table are both defined based on their respective primary keys.

32. The method of claim 29 wherein the base table and the result table include respective primary keys, the method comprising the steps of:
defining at least two indexes for the base table, one of the indexes based on the join operation and one of the indexes based on the primary key of the base table; and
defining at least two indexes for the result table, one of the indexes based on the join operation and one of the indexes based on the primary key of the result table.

33. A system for evaluating an SQL recursive query having one or base select statements and one or more recursive select statements, the query relating to a base table and having a filter condition on one or more columns from a result table returned by the query, where the system is configured to:
receive the query to be evaluated;
evaluate a base step by evaluating one or more of the base select statements;
evaluate one or more recursive steps by evaluating one or more of the recursive select statements;
evaluate the filter condition prior evaluating any of the recursive steps; and
return the result of the query.

34. A system for evaluating an SQL recursive query having one or more base select statements and one or more recursive select statements, the query relating to a base table, where the system is configured to:
receive the query to be evaluated;
evaluate a base step by evaluating one or more of the base select statements to create a result table;
delete duplicate rows from the result table;
evaluate one or more recursive steps by evaluating one or more of the recursive select statements; and
return the result of the query.

35. A system for evaluating an SQL recursive query having one or more base select statements and one or more recursive select statements, the query relating to a base table and having an aggregate function on one or more columns from a result table returned by the query, where the system is configured to:
receive the query to be evaluated;
evaluate a base step by evaluating one or more of the base select statements;
evaluate one or more recursive steps by evaluating one or more of the recursive select statements;
evaluate the aggregate function prior to evaluating any of the recursive steps; and
return the result of the query.

36. A system for evaluating an SQL recursive query having one or more base select statements one or more recursive select statements, the query relating to a base table and having a join operation between a result table returned by the query and a further table, where the system is configured to:
receive the query to be evaluated;
evaluate a base step by evaluating one or more of the base select statements;
evaluate one or more recursive steps by evaluating one or more of the recursive select statements;
evaluate the join operation; and
return the result of the query.

37. A system for evaluating an SQL recursive query having one or more base select statements and one or more recursive select statements, the query relating to a base table, and having a join operation, where the system is configured to:
receive the query to be evaluated;
define at least one index for the base table, and define at least one index for a result table returned by the query;
evaluate the join operation; and
return the result of the query.

38. A computer program stored on tangible storage media comprising executable instructions for performing a method of evaluating an SQL recursive query having one or more base select statements and one or more recursive select statements, the query relating to a base table and having a filter condition on one or more columns from a result table returned by the query, the method comprising:
receiving the query to be evaluated;
evaluating a base step by evaluating one or more of the base select statements;
evaluating one or more recursive steps by evaluating one or more of the recursive select statements;
evaluating the filter condition prior to evaluating any of the recursive steps; and
returning the result of the query.

39. A computer program stored on tangible storage media comprising executable instructions for performing a method of evaluating an SQL recursive query having one or more base select statements and one or more recursive select statements, the query relating to a base table, the method comprising:
receiving the query to be evaluated;
evaluating a base step by evaluating one or more of the base select statements to create a result table;
deleting duplicate rows from the result table;
evaluating one or more recursive steps by evaluating one or more of the recursive select statements; and
returning the result of the query.

40. A computer program stored on tangible storage media comprising executable instructions for performing a method of evaluating an SQL recursive query having one or more base select statements and one or more recursive select statements, the query relating to a base table and having an aggregate function on one or more columns from a result table returned by the query, the method comprising:
receiving the query to be evaluated;
evaluating a base step by evaluating one or more of the base select statements;
evaluating one or more recursive steps by evaluating one or more of the recursive select statements;
evaluating the aggregate function prior to evaluating any of the recursive steps; and
returning the result of the query.

41. A computer program stored on tangible storage media comprising executable instructions for performing a method of evaluating an SQL recursive query having one or more base select statements and one or more recursive select statements, the query relating to a base table and having a join operation between a result table returned by the query and a further table, the method comprising:
receiving the query to be evaluated;
evaluating a base step by evaluating one or more of the base select statements;
evaluating one or more recursive steps by evaluating one or more of the recursive select statements;
evaluating the join operation; and
returning the result of the query.

42. A computer program stored on tangible storage media comprising executable instructions for performing a method of evaluating an SQL recursive query having one or more base select statements and one or more recursive select statements, the query relating to a base table, and having a join operation, the method comprising:
receiving the query to be evaluated;
defining at least one index for the base table, and defining at least one index for a result table returned by the query;
evaluating the join operation; and
returning the result of the query.
